(19) United States
(12) Patent Application Publication
(10) Pub. No.: US 2008/0126165 A1
(43) Pub. Date: May 29, 2008

(54) Dynamic overlay metrics

(75) Inventor: Klaus Buchner, (US)

Correspondence Address: BRINKS HOFER GILSON & LIONE, P.O. BOX 10395, CHICAGO, IL, 60610, US

(73) Assignee: Siemens AG

(21) Appl. No.: 11/604,572

(22) Filed: Nov. 27, 2006

(51) Int. Cl. G05B 19/418

(52) U.S. Cl. 705/8

(57) ABSTRACT

A system and method visually depict the status of a project. A resource may be expended to complete the project. An expenditure graph depicting the total amount of the resource estimated to finish the project may be displayed. The project may have a related production schedule having a milestone. An overlay may be generated that represents the milestone. The overlay may be superimposed upon the expenditure graph. The overlay may illustrate the milestone in relation to the amount of the resource being expended to visually depict the status of the project. Updated expenditure data may be collected as the project progresses. The expenditure graph may be dynamically updated to reflect a new total amount of the resource estimated to finish the project based upon the updated expenditure data. The overlay may be dynamically altered in response to the schedule being changed to reflect a new milestone.

### BACKGROUND

The present embodiments relate generally to software applications. In particular, the present embodiments relate to software applications that facilitate monitoring the status of processes.

Business process management software applications are increasing in popularity and a number of process management software tools currently exist. MS Project™ and BizFlow™ are examples of commercially available business process management applications.

Conventional process management tools may provide process related information to the user via a display screen in a limited number of ways. For instance, typical process management tools may only present expenditure related information.

### BRIEF SUMMARY

By way of introduction, the embodiments described below include methods, processes, apparatuses, instructions, or systems for monitoring the status of projects (steps) associated with a process. Each project may have an associated schedule. The schedule may have a number of milestones or other check points. Each project may involve expending various resources. Correlating the milestones associated with the schedule with expenditure related data may yield an enhanced view of the current status of the project. For instance, an expenditure graph associated with a resource expended to complete the project may be displayed. An overlay representing a milestone may be superimposed upon the expenditure graph. As a result, the relationship between the expenditure and the milestone may be visually depicted. In one embodiment, the project monitored is associated with a business process, such as a process that develops a commercial product by researching the market and then designing, manufacturing, and testing the product.

In a first aspect, a data processing system visually depicts the status of a project. The system includes a processor operable to generate an expenditure graph depicting an amount of a resource being expended to complete the project and an overlay representing a milestone associated with the project. The system also includes a display operable to display the expenditure graph, and the processor is operable to superimpose the overlay upon the expenditure graph.

In a second aspect, a method visually depicts the status of a project. The method includes developing a schedule associated with the project, determining a remaining amount of a resource required to complete the project, and displaying an expenditure graph that depicts the remaining amount. The method also includes generating an overlay that depicts a milestone associated with the schedule and superimposing the overlay upon the expenditure graph to display the remaining amount in relation to the milestone.

In a third aspect, a method visually depicts the status of a project. The method includes graphically depicting an amount of an expenditure being spent to complete the project. The method also includes superimposing an overlay including a milestone associated with the project upon the graphical depiction.

In a fourth aspect, a computer-readable medium having instructions executable on a computer and stored thereon is described. The instructions include generating an expenditure graph corresponding to a resource being spent to complete a project and generating an overlay including a milestone associated with the project. The instructions also include superimposing the overlay upon the expenditure graph on a display to visually depict whether the project is on schedule to meet the milestone.

The present invention is defined by the following claims. Nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The present embodiments will become more fully understood from the detailed description given herein below and the accompanying drawings which are given by way of illustration only, and are not limitative of the present invention, and wherein:

FIG. 1 is an exemplary method of visually depicting the status of a project;

FIG. 2 illustrates exemplary synchronization of schedule data with expenditure data;

FIG. 3 illustrates an exemplary expenditure graph;

FIG. 4 illustrates an exemplary milestone overlay superimposed upon the expenditure graph; and

FIG. 5 is an exemplary data processing system operable to visually depict the status of the project.

### DETAILED DESCRIPTION OF THE DRAWINGS AND PRESENTLY PREFERRED EMBODIMENTS

The embodiments described herein include methods, processes, apparatuses, instructions, or systems for presenting the status of a project. The completion of the project may require that a resource be spent. Expenditure data related to the amount of the resource currently spent may be collected. Additionally, the total amount of the resource required to complete the project may be automatically estimated with a processor or expenditure metrics. An expenditure graph may be displayed that represents (1) the amount of the resource already expended and (2) an amount of the resource estimated to be required to finish the project.

The project may have a corresponding master schedule. The schedule may include a number of milestones (check points) associated with the completion of the project. An overlay may be generated that represents at least one milestone. The overlay may be superimposed upon the expenditure graph. As a result, the milestone may be demonstrated in relation to the resource (expenditure) to visually depict the status of the project with respect to the milestone and the expenditure.

Expenditure data corresponding to the amount of the resource actually expended may be collected throughout the life of the project. The expenditure graph may be dynamically altered to reflect (1) an up-to-date amount of the resource already expended and (2) a revised amount of the resource estimated to be required to finish the project based upon the up-to-date amount already spent.

The schedule may be changed for a number of reasons. For instance, the schedule may be changed in response to the current status of the project visually depicted. The status of the project depicted may reveal that the project is behind schedule, prompting a revision to the schedule. Or unforeseen events, such as design, finance, or supply difficulties, may require rescheduling. If the schedule is revised, a number of the milestones may change accordingly. The overlay may be dynamically altered to reflect an updated milestone in accordance with the revised schedule.

In one embodiment, the project monitored may be a step in a business process. The business process may involve the development of a medical device, which may include numerous tasks required to be accomplished to comply with FDA regulations. The project may be related to designing, manufacturing, or testing the medical device being developed. The medical device may be an x-ray, MRI (magnetic resonance imaging), CT (computed tomography), ultrasound, PET (positron emission tomography), or other medical device.

### I. Exemplary Method

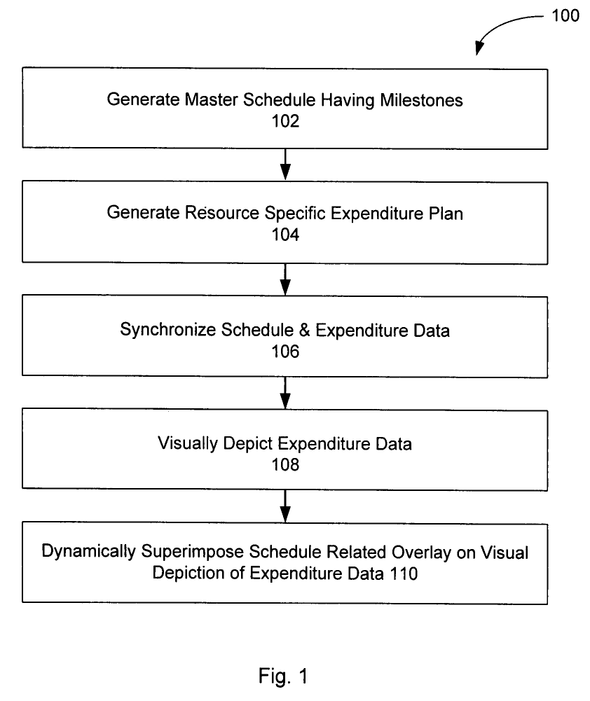

FIG. 1 demonstrates an exemplary method of graphically depicting the status of a project 100. The method may include generating a master schedule having at least one milestone 102, generating a resource-specific expenditure plan 104, synchronizing schedule data with expenditure data 106, visually depicting the expenditure data 108, and dynamically superimposing a milestone overlay onto the expenditure data 110. The method may include additional, fewer, or alternate actions.

The method may include generating a master schedule 102. In a master plan (for instance, a plan generated using a software tool such as MS Project™), project-specific timelines and milestones may be recorded to generate corresponding schedule data. The schedule data may be stored in a memory that includes a multi-dimensional data structure, such as a table or a time grid. The data structure may have dimensions dedicated to time, expenditures, milestones, and/or other project related characteristics. Other data structures may be used.

The schedule may include one or more milestones. In general, a milestone may be a date within the schedule by which something is scheduled to be completed. The milestones also may be decision points, review points, or other check points associated with the project. A decision point may be a point in a developmental process where documents, such as technical designs or testing results, are to be reviewed and must be completed before a next task may be commenced (as some tasks may be required to be completed in a linear fashion). A review point may be a designated point in the project schedule at which management needs to review the status of the project. For example, a particular point in the project may be required to be reached before further financing is obtained. Other milestones may be used.

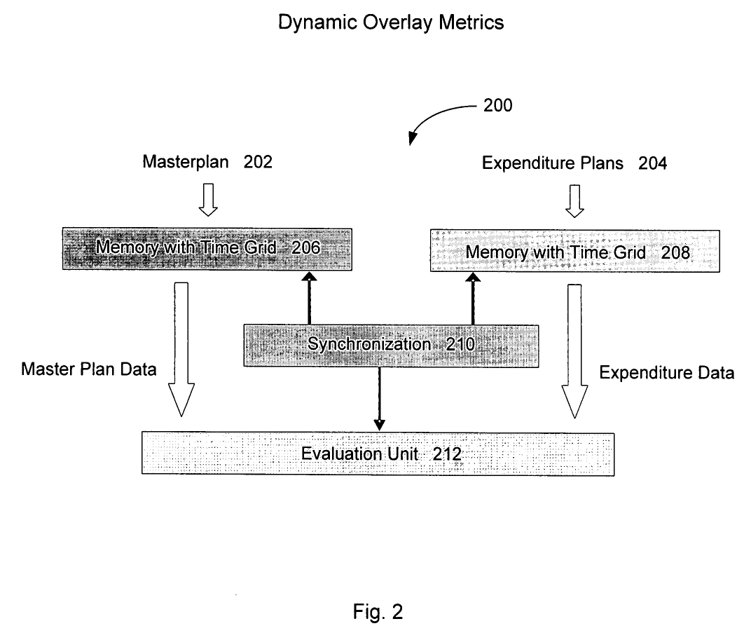

To further illustrate, FIG. 2 depicts an exemplary synchronization of the schedule data with expenditure data 200. A master plan or schedule 202 may be generated, such as with a software tool. The schedule data defining the master plan 202 may be stored in a multi-dimensional time grid 206, as shown.

The method 100 may include generating a resource-specific expenditure plan 104. A resource-specific expenditure plan may be generated (such as a MS Project™ plan) using a software tool. The tool may facilitate identifying one or more expenditures to monitor and generate an expenditure plan for each of the expenditures. Expenditure data corresponding to a selected expenditure may then be collected by a processing system.

The expenditure data collected may relate to a number of “planning values” selected to be monitored in accordance with the expenditure plan. For instance, planning values may relate to specific projects, components, account numbers, resource information, man hours, materials, lab time, floor or storage space, or other resources.

The expenditure data obtained may be regularly updated and stored within a time grid or other multi-dimensional data structure. FIG. 2 illustrates expenditure data associated with the expenditure plan 204 may be stored in a multi-dimensional time grid 208. Similar to the schedule data, the expenditure data may be stored in a data structure, such as a table, grid, queue, tree, stack, list, or other data structure, associated only with one corresponding project. Alternatively, the schedule and/or expenditure data may be associated with a flag or other identifier that denotes the corresponding project to which the schedule and/or expenditure data belongs, respectively.

The method 100 may include synchronizing the schedule and expenditure data 106. In a processor, operations may be performed upon the schedule and expenditure data stored. Both the schedule and expenditure data may be represented on a display in summarized form via predetermined computation algorithms or in filtered form via various metrics. If the data is stored in a time grid and assigned a time, information from the schedule, such as project timelines and milestones, may be synchronously linked with metrics generated by an expenditure planning tool.

The expenditure metrics may be organized and/or displayed with respect to corresponding projects. Simultaneously, current information from one or more project schedules may be associated synchronously with expenditure data. As a result, as discussed in more detail elsewhere herein, milestones may be dynamically superimposed over displayed expenditure information to visually depict a project potentially not meeting a milestone with respect to a particular expenditure.

FIG. 2 illustrates that memories storing both schedule data 206 and expenditure data 208 may be accessed by a processing unit 212 to synchronize 210 the data. The schedule and expenditure data may be correlated by time and/or project. The synchronization of the schedule and expenditure data may be facilitated by storing the schedule and expenditure data in similar data structures, such as multi-dimensional data structures having corresponding dimensions dedicated to project, time, and/or other information. The synchronization may facilitate presenting the status of a project with respect to the schedule and the resource being expended.

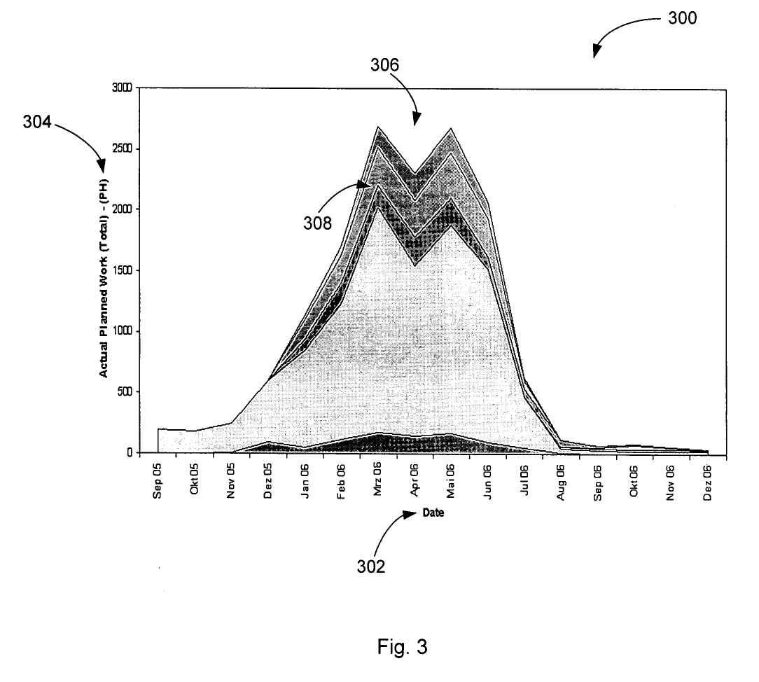

The method 100 may include visually depicting the expenditure data 108. FIG. 3 illustrates an exemplary visual depiction of expenditure data 300. The expenditure data may correspond to a specific resource being expended to complete a project. The visual depiction of the expenditure data 300 may include a timeline 302, a resource line 304, an expenditure graph 306, and color coding 308. The visual depiction of the expenditure data may include additional, fewer, or alternate graphics.

The timeline 302 may include a number of dates. The timeline may represent time as one dimension of the expenditure graph 306. The exemplary timeline 302 of FIG. 3 demonstrates time by month. Other time periods may be used. Time may be represented by events, such as associated with a linear process or different projects.

The resource line 304 may represent the amount of a resource being expended on the corresponding project. The exemplary resource line 304 of FIG. 3 demonstrates planned work hours in units of 500. Other resources, as well as other unit scales, may be depicted.

The visual depiction of the expenditure graph 306 may be a multi-dimensional graph. The graph 306 may represent actual expenditures, forecasted expenditures, or a combination of actual and forecasted expenditures for a particular resource. The exemplary graph 306 shown in FIG. 3 is a two-dimensional graph that illustrates that the total amount of work hours by month increased for the corresponding project after the project began. Near the scheduled completion of the project, the amount of work hours per month is expected to decrease significantly. Other expenditure graphs may be used.

The expenditure graph 306 may include color coding 308. The color coding may represent different items of information. For instance, the color coding 308 may represent overtime pay associated with a project. Time and a half hours, double time hours, and triple time hours associated with the project may be represented near the top of the expenditure graph, while work performed at normal hourly wages may be represented on the bottom on the expenditure graph, as shown in FIG. 3.

The expenditure graph may represent a number of resources being expended to complete a project simultaneously, such that a status of the project may be ascertained with respect to a plurality of expenditures. Each expenditure may have a dedicated color. A color scheme may be selected to represent the status of the project with respect to a number of expenditures or the status of the expenditures with respect to each other, such that the viewer may visually ascertain which of the expenditures being spent on the project are behind or ahead of schedule.

Alternatively, the color coding 308 may depict different tasks associated with the project. The color coding may represent the amount of the resource expended on each task. Color coding may represent other information.

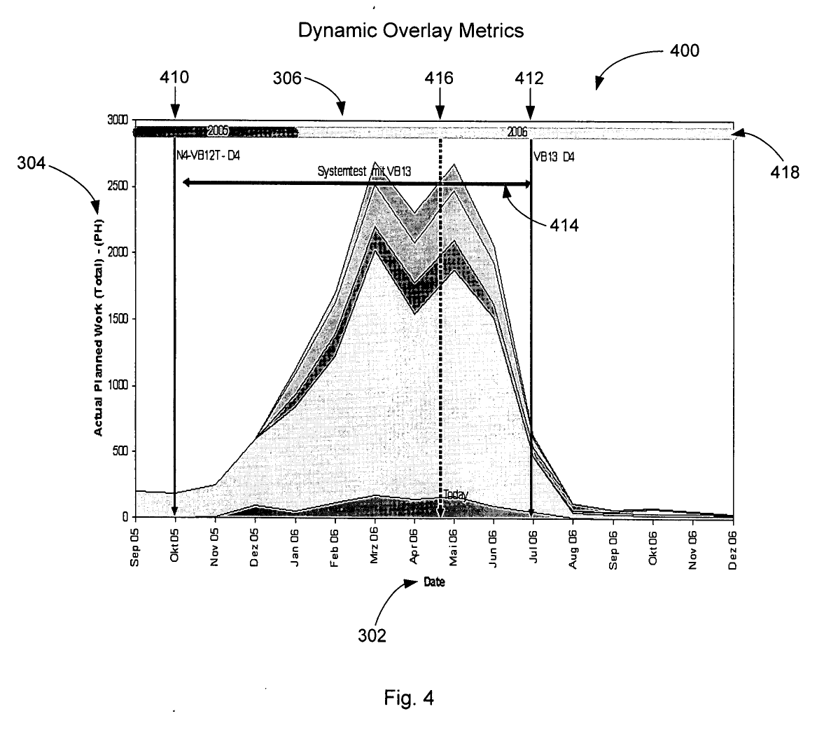

The method 100 (FIG. 1) may include dynamically superimposing a schedule related overlay upon the expenditure data 110. For instance, the overlay may represent a milestone defined by the schedule data. FIG. 4 illustrates an exemplary overlay 400 superimposed upon the expenditure data. The overlay may include a start icon 410, a scheduled end icon 412, a project icon 414, a date icon 416, and a calendar icon 418. The overlay may include additional, fewer, or alternate icons.

The start icon 410 may visually depict the date that the project began (in accordance with the schedule data). The scheduled end icon 412 may visually depict the date that the project is scheduled to be completed (in accordance with the schedule data) or was completed. The start and end icons 410, 412 depicted are arrows. Other start and end icons may be used.

The project icon 414 may demonstrate how long the project is currently scheduled to take (in accordance with the schedule data) or did take. The project icon 414 may be shown on the overlay in relation to the start and end icons 410, 412. The project icon may employ a color scheme to demonstrate the status of the project. For instance, if the project is currently on schedule, the project icon may be yellow, if the project is ahead of schedule, the project icon may be green, and if the project is behind schedule, the project icon may be red. Other project icons may used.

The display may demonstrate (1) the actual amount of the resource already expended, (2) the forecasted amount estimated to complete the remaining portion(s) of the project, and (3) an estimated total amount of the resource to be spent on the project by the displaying the actual and forecast amounts together. For example, the date icon 416 may represent today's date. The amount of the resource depicted within expenditure graph to the left hand side of the date icon 416 may represent the actual amount of the resource already expended on the project. The amount of the resource depicted within the expenditure graph to the right hand side of the date icon 416 may represent an amount of the resource forecasted to be required to complete the project. In the example shown in FIG. 4, the amount of the resource shown to the left of the date icon 416 represents the man hours already spent and the amount shown to the right of the date icon 416 represents the man hours calculated to complete the project going forward.

The date icon 416 may be selected and moved by a user. For instance, the user may select the date icon 416 with a mouse and move it left or right over the expenditure graph. Moving the date icon 416 to the left of the current date may cause the display to show a number representing the actual amount of the resource spent from the current date back to the corresponding date the user selects by moving the date icon 416. As a result, the actual amount of the resource expended for the last month, last quarter, last year, or other period the user is interested in may be displayed in numerical form.

Likewise, moving the date icon 416 to the right of the current date may cause the display to show a number representing a forecasted amount of the resource estimated to be spent from the current date to the corresponding date the user selects. As a result, the forecasted amount of the resource for the next month, next quarter, next year, or other period looking forward may be displayed in numerical form.

The calendar icon 418 may represent the dates to which the icons and other items displayed on the overlay correspond to. The calendar icon 418 may be used to facilitate visually aligning the dates associated with the milestone and schedule with the dates associated with the expenditure data 302. The calendar icon 418 may employ different color schemes for different time periods being represented. For instance, each month or year may have a different color. Other calendar icons may be used.

FIG. 4 depicts an expenditure graph associated with man hours. The man hours to the left of the date icon 416 have already been expended, while the man hours to the right of the date icon 416 are forecasted to be necessary to finish the project. The overlay generated from the schedule data demonstrates a milestone associated with the man hours to be expended on the project depicted. The project is scheduled to be completed by July 2006, as shown. Hence, any man hours spent on the project after the currently scheduled end date 412 would be unexpected when viewing the schedule or expenditure graph in isolation.

However, as shown in FIG. 4, some man hours are forecasted to be expended past the July 2006 scheduled end date 412. Accordingly, viewing the expenditure data in combination with the schedule related overlay alerts the viewer that a milestone associated with the project, in this case the total amount of man hours with regard to the scheduled completion date, is in danger of not being met given the current circumstances. In other words, whether the project is in danger of missing a milestone with respect to the expenditure is visually depicted.

At which point, a determination may be made to reallocate resources or allocate more resources to get the project back on schedule. A processor may analyze all of the available resources and the status of the project to estimate a reallocation of resources, or an allocation of additional resources, to return the project to schedule. For instance, resources, such as engineering or manufacturing personnel, from a different project (such as one ahead of schedule) may be temporarily reallocated or reassigned to a project behind schedule. Other reallocations of resources may be made.

The expenditure graph may be dynamically updated. As the project continues, the expenditure data may be routinely updated to reflect the current amount of the resource expended on the project. The portion of the expenditure graph depicting the actual amount of the resource already expended may be revised to visually depict the up-to-date actual amount. The up-to-date actual amount may be used to calculate a revised forecasted amount of the resource estimated to be required to finish the project. The portion of the expenditure graph depicting the forecast amount may be revised to visually depict the revised forecasted amount. Accordingly, by dynamically updating the underlying expenditure graph having an overlay superimposed, an updated status of the project is visually depicted with respect to the milestone and the revised expenditure.

The overlay may be dynamically updated. As the project continues, the schedule may be revised for a number of reasons. The milestone may be revised in kind. The overlay superimposed upon the expenditure graph may be updated to reflect the current schedule and the revised milestone. Accordingly, dynamically altering the overlay upon the expenditure graph may visually depict an updated status of the project with respect to the revised milestone and the expenditure. In one embodiment, both the overlay and the expenditure graph may be dynamically updated, either individually or simultaneously.

The overlay may represent a plurality of milestones with respect to the expenditure(s) being depicted by the expenditure graph. Each of the milestones, as well as each of the expenditures, may be associated with a color scheme to reflect the current status of a specific expenditure with regard to a milestone. All of the icons related with a specific milestone may be shown in one or similar colors, such as shades of blues, reds, or greens. Other color coding may be used.

### II. Exemplary Data Processor

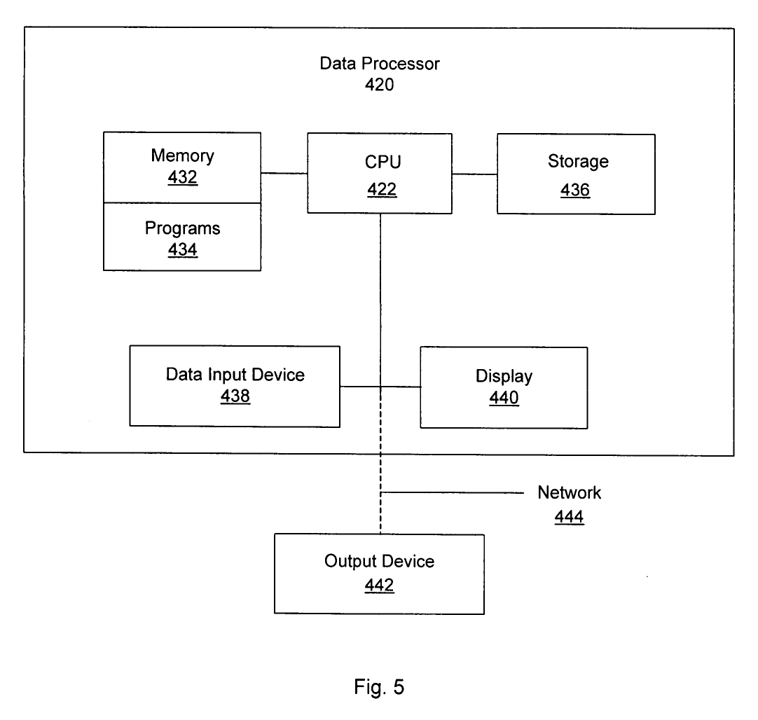

The method for visually depicting the status of a project may be facilitated by a data processing system. FIG. 5 is a block diagram of an exemplary data processor 420 configured or adapted to provide functionality for collecting schedule and expenditure data, displaying expenditure graphs, and superimposing milestones generated from the schedule data onto the expenditure graphs. The data processor 420 may include a central processing unit (CPU) 422, a memory 432, a storage device 436, a data input device 438, and a display 440. The data processor 420 also may have an external output device 442, which may be a display, a monitor, a printer or a communications port. The data processor 420 may be a personal computer, work station, server, or other system. The data processor 420 may be interconnected to a network 444, such as an intranet, the Internet, or an intranet connected to the Internet. The data processor 420 may be interconnected to another location via the network 444 either by data lines or by wireless communication. The data processor 420 is provided for descriptive purposes and is not intended to limit the scope of the present system. The data processor may have additional, fewer, or alternate components.

A program 434 may reside on the memory 432, storage device 436, or another memory (e.g., hard drive removable media, RAM, or network buffer). The program 434 may include one or more sequences of executable code or coded instructions that are executed by the CPU 422. The program 434 may be loaded into the memory 432 from the storage device 436 or network or removable media. The CPU 422 may execute one or more sequences of instructions of the program 434 to process data. The program 434 may provide functionality as discussed herein.

Schedule and expenditure related data may be entered via the data input device 438 or another input device, or received via the network 444 or other network. The data processor 420 may receive and store the schedule and expenditure data received in the memory 432, the storage device 436, or other storage unit. The program 434 may direct that the data received be stored on or read from machine-readable medium, including secondary storage devices such as hard disks, floppy disks, CD-ROMS, and DVDs; electromagnetic signals; or other forms of machine readable medium, either currently known or later developed.

The program 434 may instruct the data processor 420 to depict the schedule and/or expenditure related information in one or more windows on the display 440, the external output device 442, or other display screen. The schedule and/or expenditure related information may be depicted visually or textually. The visual depictions may include two or three dimensional graphs, such as bar charts, pie charts, tables, or other graphical depictions. The data processor 420 may retrieve the schedule and/or expenditure data from machine-readable medium, including secondary storage devices such as hard disks, floppy disks, CD-ROMS, and DVDs; electromagnetic signals; or other forms of machine readable medium, either currently known or later developed.

The program 434 may direct the data processor 420 to scroll through a visual or textual depiction of schedule and/or expenditure related information. The data processor 420 may divide the display 440, output device 442, or other display screen into multiple virtual sub-regions. Each of the virtual sub-regions may be associated with a specific project, schedule, and/or expenditure. For instance, the display may be split into four quadrants. Other sub-regions may be provided.

The data processor 420 may cause display of milestone information and an expenditure graph on the display 440, output device 442, or other display screen. The milestone may correspond to a key date provided for by a corresponding project schedule. The expenditure graph may correspond to a resource being expended to complete the project. The data processor 420 also may display icons on the display 440, output device 442, or other display screen. The display 440, output device 442, or other display screen may be a touch screen, a touch pad, a haptic device, or other vibrational or physical feedback device.

The user interface may accept one or more operations performed on the display and/or icons to reveal further information. For instance, the user interface may provide for the selection and display of a dedicated schedule page after the user clicks upon a milestone related icon. The dedicated schedule page may present further textual or graphical information related to the schedule and/or project. The user interface also may present further textual or graphical information related to a specific milestone or other check point after user selection. Other operations may be performed

The data processor 420 may cause generation of an overlay from the schedule data. The overlay may include one or more milestone icons associated with the completion of the project. Subsequently, the data processor 420 may superimpose the overlay over a graph an expenditure being used to accomplish the project on the display 440, output device 442, or other display screen. Additionally, the data processor 420 may generate additional icons to which to include within the overlay and superimpose over the expenditure graph on the display 440, output device 442, or other display screen. A user interface may accept one or more operations performed upon the icons and/or overlay superimposed on the expenditure graph.

While the invention has been described above by reference to various embodiments, it should be understood that many changes and modifications can be made without departing from the scope of the invention. The description and illustrations are by way of example only. Many more embodiments and implementations are possible within the scope of this invention and will be apparent to those of ordinary skill in the art. The various embodiments are not limited to the described environments and have a wide variety of applications.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except in light as necessitated by the accompanying claims and their equivalents.

1. A data processing system for visually depicting the status of a project, the system comprising:
a processor operable to generate an expenditure graph depicting an amount of a resource being expended to complete a project and an overlay representing a milestone associated with the project; and
a display operable to display the expenditure graph, wherein the processor is operable to superimpose the overlay upon the expenditure graph.

2. The system of claim 1, wherein the processor is operable to monitor an actual amount of the resource expended during the project and dynamically update the expenditure graph as the actual amount of the resource expended changes.

3. The system of claim 2, wherein the processor is operable to forecast a remaining amount of the resource required to complete the project, and the expenditure graph depicts both the actual and remaining amounts.

4. The system of claim 3, wherein the overlay includes an icon representing the currently scheduled end of the project such that superimposing the icon upon the remaining amount displayed visually depicts the status of the project.

5. The system of claim 3, wherein the overlay includes an icon representing the current date in relation to the remaining amount and the milestone.

6. The system of claim 5, wherein the resource monitored is man hours.

7. The system of claim 1, wherein the processor is operable to generate the overlay representing the milestone from schedule data associated with the project.

8. The system of claim 7, wherein the processor is operable to dynamically update the overlay representing the milestone if a schedule defined by the schedule data changes.

9. The system of claim 7, wherein the project is associated with the development of a medical device.

10. A method of visually depicting the status of a project, the method comprising:
developing a schedule associated with a project;
determining a remaining amount of a resource required to complete the project;
displaying an expenditure graph that depicts the remaining amount;
generating an overlay that depicts a milestone associated with the schedule; and
superimposing the overlay upon the expenditure graph to display the remaining amount in relation to the milestone.

11. The method of claim 10, the method comprising:
monitoring an actual amount of the resource already expended during the project;
updating the remaining amount based upon the actual amount; and
dynamically altering the expenditure graph to display the updated remaining amount in relation to the milestone to visually depict an updated status of the project.

12. The method of claim 10, the method comprising:
changing the schedule;
dynamically altering the overlay displayed to reflect the change in the schedule to visually depict an updated status of the project.

13. The method of claim 10, wherein the project involves designing, manufacturing, or testing a medical device.

14. The method of claim 13, wherein the resource is man hours.

15. A method of visually depicting the status of a project, the method comprising:
graphically depicting an amount of an expenditure being spent to complete a project; and
superimposing an overlay including a milestone associated with the project upon the graphical depiction.

16. The method of claim 15, the method comprising:
determining a spent amount of the expenditure already expended; and
forecasting a remaining amount of the expenditure necessary to complete the project, wherein the graphical depiction reflects both the spent and remaining amounts.

17. The method of claim 16, the method comprising dynamically updating the graphical depiction displayed based upon the spent amount.

18. The method of claim 17, the method comprising dynamically updating the overlay to reflect the milestone being changed.

19. The method of claim 15, the method comprising dynamically updating the overlay to reflect the milestone being changed.

20. A computer-readable medium having instructions executable on a computer stored thereon, the instructions comprising:
generating an expenditure graph corresponding to a resource being spent to complete a project;
generating an overlay including a milestone associated with the project; and
superimposing the overlay upon the expenditure graph on a display to visually depict whether the project is on schedule to meet the milestone.

21. The computer-readable medium of claim 20, the instructions comprising determining a remaining amount of the resource required to complete the project, wherein the remaining amount is depicted in the expenditure graph by time for visual comparison with the milestone.

22. The computer-readable medium of claim 20, the instructions comprising dynamically altering the expenditure graph as a spent amount of the resource actually expended on the project changes.

23. The computer-readable medium of claim 20, the instructions comprising dynamically altering the overlay in response to the milestone being changed.
